(19) United States
(12) Patent Application Publication
(10) Pub. No.: US 2011/0005963 A1
(43) Pub. Date: Jan. 13, 2011

(54) Combo Hair or Fur Grooming Kit with an Accessories Compartment

(76) Inventor: Cordellia Mapalo, Woodland, CA (US)

Correspondence Address: CORDELLIA MAPALO, 232 WEBER STREET, WOODLAND, CA, 95695, US

(21) Appl. No.: 12/501,432

(22) Filed: Jul. 12, 2009

(51) Int. Cl. B65D 69/00

(52) U.S. Cl. 206/581; 206/223

(57) ABSTRACT

A Combo Hair or Fur Grooming Kit with an Accessories Compartment, this grooming kit can be taken on the go, or used at home anytime. This Combo Hair or Fur Grooming Kit with an Accessories Compartment keeps human hair and most pet fur styling all day and night without worrying that you will need other tools or products. This Grooming Kit can be carried in a purse, in a pocket, in a automobile, trailer, boat, it is small and a complete styling kit with an Accessories Compartment for hair or fur clips, rubber bands, ties, etc. This Combo Hair or Fur Grooming Kit with an Accessories Compartment is housed in a one piece attractive plastic cylinder and can be carried and used with one hand. By having workable styling tools housed within its torso it is fun and convenient anytime or anywhere. Encased within the torso will be a comb or brush, spray bottle for hair or fur liquid products solutions and an accessories compartment for clips, rubber bands, handkerchiefs, clippers, nail boards, etc. This Combo Hair or Fur Grooming Kit with an Accessories Compartment will be an improvement over other Hair and Fur products because it will be a complete styling tool and accessible at all times.

### FIELD OF INVENTION

The present invention relates to the field of A Combo Hair or Fur Grooming Kit with an Accessories Compartment in general, and particular to a conveniently located, readily accessible, complete grooming kit with a build in accessories compartment all combined into this Completely Portable Lightweight Handheld Grooming Kit for use on human hair or pet fur.

This Combo Hair or Fur Grooming Kit with an Accessories Compartment can be stored under the sink, in a small cabinet, in a boat, in a purse, in a suitcase, in your travel bag, your car console, the window side pocket or glove compartment of your car; it is so small and convenient. This amazing Grooming Kit comes with a spray bottle in the top, to hold your favor hair or pets styling products, a comb on the side to style your hair or pet fur and a accessories compartment for all your hair or pets fur needs, it a complete package. The spray nozzle, cap, comb and accessories are all that is needed to completely keep you hair or your pet fur under control in any situation.

This Combo Hair or Fur Grooming Kit with an Accessories Compartment is in itself a complete hair or fur grooming kit, each kit includes a spray bottle with pump and cap for your favorite styling products, a comb or a brush for you to style your hair or your pets fur into a luscious beauty and a special accessories compartment to store all the hair or your pets accessories needed to give you or them a different look each hour of the day.

### BACKGROUND OF INVENTION

My self contained Grooming Kit which contains a spray bottle for styling solutions, at the top of an elongated plastic cylinder, a comb or brush connected to the side of an elongated plastic cylinder and a compartment for holding accessories at the bottom of an elongated plastic cylinder could not be found in any US Patents searches.

This present inventions relate to combining a spray bottle for sprayable grooming solutions with a comb or brush into an elongated plastic cylinder that allows for the storage of accessories at the bottom of the elongated plastic cylinder. At the bottom of this elongated plastic cylinder is a closure keeping the accessories secured with a closure which would not allow for the lost of the accessories stored in such device. This device is more particularly to portable, self contained units. No inventions were found that claim to have workable tools capable of affording the operator the use of a grooming fluid sprayer, a comb or brush and storage areas with a closure. None of the US Patents inventions provide a compressed container of a novel type that effectively serve as the housing unit for any of the grooming tool mounting thereon in my invention.

I found no devices that fulfill my particular objective. My invention discloses a new portable, self contained, convenient, lightweight combination of grooming tools combined with a storage unit. Some inventions encompass elongated combs or dryers elongated resiliently flexible comb blades, compressible sponge members and a resiliently compressible scrubbing pad that are not of easy access to a user for immediate use.

In this respect, the Combo Hair or Fur Grooming Kit with an Accessories Compartment according to the present invention is substantially different from the conventional concepts and designs of any prior art, and in so doing provides a new art apparatus developed to groom hair or fur and store accessories in a compartment connected to a comb/brush and a spray bottle that also adds in particular the convenient location and easy access to this kit do to its size and shape. This invention can be stored in a purse, car, console, side window pocket, in a small cabinet or even a backpack. The receptacle or housing unit of my present invention is made of a lightweight plastic and will not rust or scratch any surface. The receptacle or housing unit of this new Combo Hair or Fur Grooming Kit with an Accessories Compartment can come in many different colors or within a cloth casing.

### SUMMARY OF THE INVENTION

It is the intention of this invention to provide A Combo Hair or Fur Grooming Kit with an Accessories Compartment with self contained tools which will improve the convenience and easy access to a Grooming device which will help style human hair or pet fur at any particular point in time by being small, accessible and a complete styling solution at any particular point in time. It is the intention of this invention to provide easy access and easy storability of this Combo Hair or Fur Grooming Kit with an Accessories Compartment within the reach of the any one needing an emergency hair styling or any pet needing emergency fur styling. This invention is designed to be conveniently stored in purses, backpacks, cars, RV's, bathrooms, in kitchen cabinets, bathroom cabinets, boats, travel trailers or to just sit in glove compartment of a vehicle.

This invention is a three component grooming kit that includes a spray bottle for spraying hair styling solutions, fur cleaning solutions or detangling solutions, a soft rubber comb or brush to clean or style human hair or pet fur and an accessories compartment to hold all hair accessories needed to style your human hair or your pet fur.

This Combo Hair or Fur Grooming Kit with an Accessories Compartment invention according to the present inventions is substantially different from the conventional concepts and designs of any prior art. This invention provides a new use for a spray bottle, a comb or brush and an accessories compartment which is all combined into a new art apparatus and housed in a receptacle or housing unit in any color and shape. This invention was developed to be A Combo Hair or Fur Grooming Kit with an Accessories Compartment for easy access when styling human hair or when styling pet fur, with particular attention to its new convenient of a complete grooming tool and convenient storage locations and easy access. This invention made of a plastic is rust proof and waterproof and is an excellent grooming tool for any outing or at home usage.

### BRIEF DESCRIPTION OF THE DRAWINGS

An embodiment of the present invention will now be disclosed, by way of, illustrations in reference to the following drawings in which:

FIG. 1 is a perspective view of an embodiment of an “A Combo Hair or Fur Grooming Kit with an Accessories Compartment” from the side according to the present invention when in use.

FIG. 2 is a perspective view of an embodiment of the “Combo Hair or Fur Grooming Kit with an Accessories Compartment” from the underside according to the present invention when in use.

FIG. 3 is an exploded perspective view of an embodiment of the “Combo Hair or Fur Grooming Kit with an Accessories Compartment” according to the present invention assembled when in use.

FIG. 4 is an exploded perspective view of an embodiment of the accessories tube receptacle at the bottom of the “Combo Hair or Fur Grooming Kit with an Accessories Compartment” with the end cap inserted to show how it will attach to the bottom of the accessories tube receptacle of the invention.

FIG. 5 is an exploded perspective view of an embodiment of the receptacle or housing unit of the “Combo Hair or Fur Grooming Kit with an Accessories Compartment” without the accessories attached to the invention.

FIG. 6 is a perspective view of an embodiment of the receptacle or housing unit of the “Combo Hair or Fur Grooming Kit with an Accessories Compartment” with the top portion showing the threads for the attachment of the spray nozzle pump, pump tube and cap of the invention.

FIG. 7 is a perspective view of an embodiment of the receptacle or housing unit of the “Combo Hair or Fur Grooming Kit with an Accessories Compartment” showing the openings for comb/brush and the accessories tube receptacle. FIG. 7 is additionally displaying an exploded embodiment of the base and comb/brush which will be inserted into the middle opening in the embodiment of the receptacle or housing unit. The base, which can be made of plastic, styrofoam, wood or a resilient material, and a comb/brush, strip made of plastic or metal material, will be assembled together with glue, stitched or made as a whole piece of elongated plastic or metal material that will whole the comb/brush for this invention.

FIG. 8 is a view similar to FIG. 7, presenting the embodiment of the “Combo Hair or Fur Grooming Kit with an Accessories Compartment” with an exploded drawing of the accessories tube receptacle when inserted into the drawing next to the opening in the receptacle or housing unit in which the accessories tube receptacle will be placed into the invention.

FIG. 9 is a view similar to FIG. 8, presenting the embodiment of the “Combo Hair or Fur Grooming Kit with an Accessories Compartment” with the receptacle or housing unit assembled displaying the accessories tube receptacle end cap inserted into the housing unit attached with glue, threads or stitching closing the bottom of the compartment of the embodiment.

FIG. 10 is the “Combo Hair or Fur Grooming Kit with an Accessories Compartment” additionally displaying additional variations of the end closures of the “Combo Hair or Fur Grooming Kit with an Accessories Compartment” that could possible be attached to the end of the compartment as opening for other types on paper products that could be used with this invention.

### DETAILED DESCRIPTION OF PREFERRED EMBODIMENTS OF THE INVENTION

With reference to the drawings in general, the drawings illustrate “A Combo Hair or Fur Grooming Kit with an Accessories Compartment” and more precisely a portable, lightweight, self-contained, easy accessible receptacle or housing unit primarily adapted for combing or brushing the hair of an human or an animal. These drawings will describe the current embodiment, it will be understood that I do not intend to limit the Combo Hair or Fur Grooming Kit to this embodiments. This embodiment will come in various sizes and colors. I will cover and describe differences, alternatives and modifications as may be included within the spirit and scope of these embodiments.

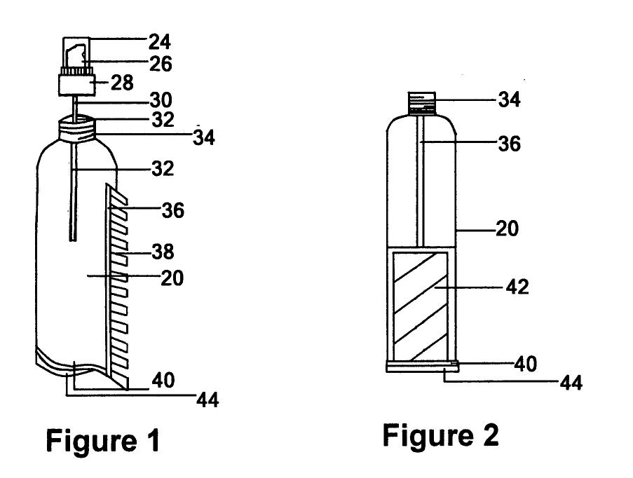

FIG. 1 is an illustration showing the perspective view from the front side and an exploded view of the embodiment's nozzle pump 26 and cap 24 of the presented “Combo Hair or Fur Grooming Kit with an Accessories Compartment” 22. The embodiments of the basic receptacle or housing unit 20 will be molded of various hard plastics in different widths and lengths of plastic. This embodiment 20 will consist of many different lengths and widths of plastics. The embodiment of the body of the receptacle or housing 20 units is made to hold the spray bottle 28, 26, 24, 30, a comb or brush 38, a base 36 or a combined comb/brush base 38, 36 and at the bottom opening 40 of the accessories tube, is the end closure 44 to hold the accessories in the accessories compartment 44. The top portion 34 of the receptacle or housing unit 20 of the embodiment will be used for attaching the cap 24 of the spray bottle 28, the pump nozzle 26, and the stem of the spray bottle 30. The top portion 34 of the receptacle or housing unit 20 will also contain threads 34 to attach the spray bottle neck 28 of the receptacle or housing unit 20. The top opening 34 of the receptacle or housing unit 20 will be used for connecting the nozzle 26 of the spray bottle, tube 30 within the spray bottle, and the base of the spray bottle 28. The middle opening 36 of the receptacle or housing unit 20 will be used to conceal the base 36 or handgrip of the comb or brush 38 and elongated flexible comb or brush 38 blades or a unit combination of both base and comb or brush 36, 38. The bottom opening 40 of the receptacle or housing unit 20 will be used for concealing the accessories tube receptacle 42 which is presented in this embodiment as a generally cylindrical inter configuration.

FIG. 2 illustrates the embodiment of the “Combo Hair or Fur Grooming Kit with an Accessories Compartment” 22 receptacle or housing unit 20. It is showing the treads 34 molded into the receptacle or housing unit 20, the molded middle opening 36 which will hold the comb or brush. This figure show the inserted accessories tube receptacle 42 inserted into the molded bottom end 40 on the receptacle or housing unit 20. This figure again shows the end closure 44 of bottom opening in the accessories tube receptacle 42.

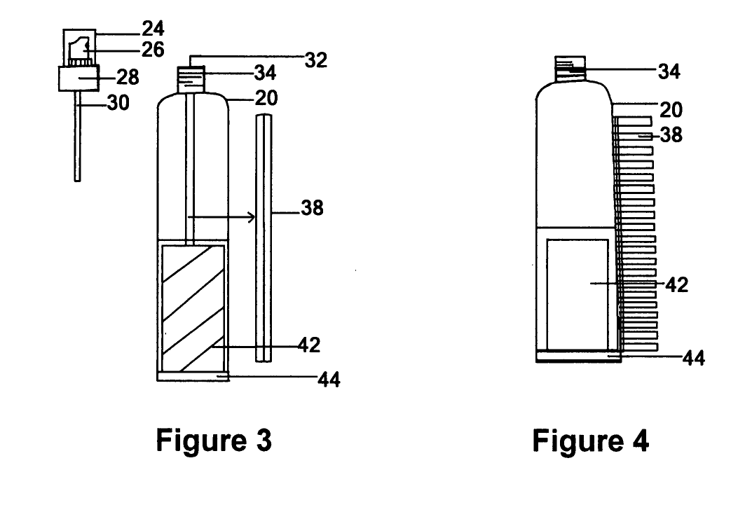

FIG. 3 illustrates a perspective view of the receptacle or housing unit 20 of the embodiment of the “Combo Hair or Fur Grooming Kit with an Accessories Compartment” 22. The embodiment shows the exploded view of the stem of spray nozzle 30, the neck of spray bottle 28, the nozzle of spray bottle 26, and the cap of spray bottle 24. This figure start at the top opening the housing unit 32, indicating the threads on housing unit 34, the molded receptacle or housing unit 20, the middle opening of housing unit 38, and the accessories tube receptacle 42 for insertion into the bottom opening of the housing unit 40. This receptacle or housing unit 20 can range in size from approximately 4-18 inches in length and ½-1½ inches is width. This receptacle or housing unit 20 can be made out of any material to shape the shape can be held and formed into this molded unit mainly any types of plastic or cement. This figure again shows the end closure 44 of the accessories tub receptacle 42.

FIG. 4 illustrates the perspective side view of the combo Hair or Fur Grooming Kit with an Accessories Compartment 22 receptacle or housing unit 20 of the embodiment with the top opening 32 threads exposed to show the threads 34 of the housing unit 20 assembled. The top opening portion 32 is generally circular in configuration; however, could be squared or any other shape. This figure is showing the middle opening 36 of the housing unit with the comb 38 attached and in place. The accessories tube receptacle 42 is being shown in place with the end closure 44 in place to show how the closure will hold in the accessories.

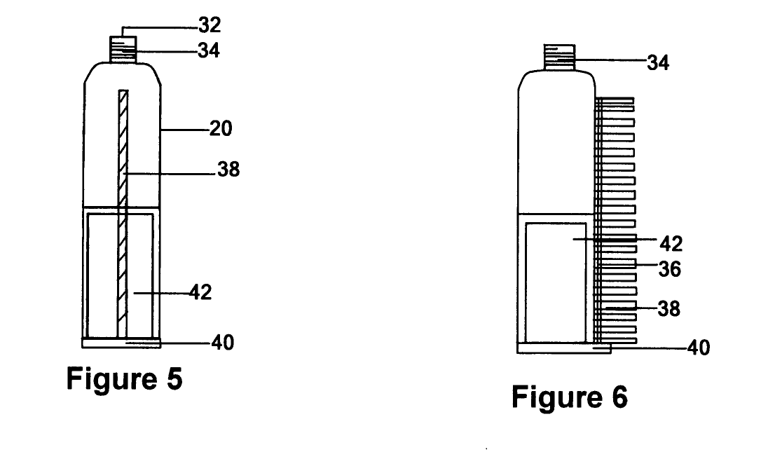

FIG. 5 illustrates a perspective view of the receptacle or housing unit 20 of the Combo Hair or Fur Grooming Kit with an Accessories Compartment 22. Again this embodiment shows the top portion 32 of the receptacle or housing unit 20, with the top opening 32, the middle opening with base for the comb 38 and rear opening 40 with the accessories tube receptacle 42 inserted into the housing unit.

FIG. 6 illustrates a perspective view an embodiment similar to FIG. 5 displaying the base 36, and comb 38 inserted into the receptacle or housing unit 20 of the embodiment. This base 38 with comb 36, will have a generally square or rectangle design for grasping with the hand of the user. In the displayed embodiment, the gripping portion of the base 36 has a generally circle configuration and generally has a length greater than the width. The base 36 of the base and comb 36, 38 can be approximately 4-8 inches in length and ½-2 inches in width. This base 36 can be constructed of rubber, metal, wood, Styrofoam or plastic. This combination base 36, and comb 38 can be constructed of rubber or a resilient plastic or any other material known to one skilled in the art of manufacturing combs. It is hereby referenced that the comb 38 and base 36 can be bonded as one or configured as a combined base and comb made out of the reference material above. This base with comb molded together 36, 38 design serves as a handle for manipulating the comb or brush 38 while the relatively flexible resilient blade will economically provide for the styling of human hair or pet fur. FIG. 6 illustrates the approximate placement of the accessories tube receptacle embodiment and the bottom opening 40 of the hosting unit 20.

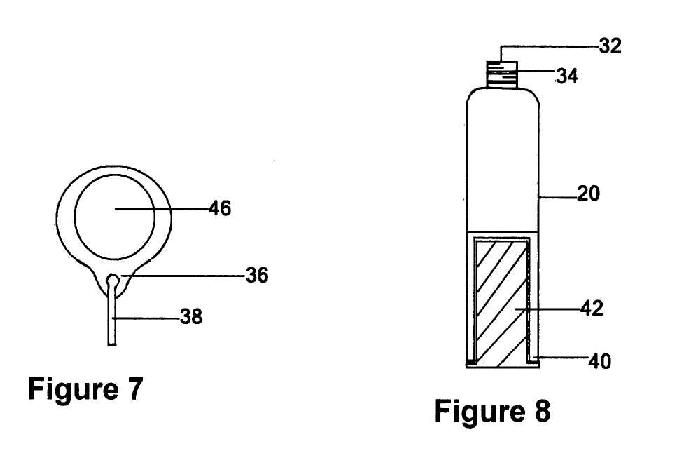

FIG. 7 illustrates a perspective sliced view and the Combo Hair and Fur Grooming Kit with Accessories Compartment 22 embodiments. This view shows the interior of the housing unit 46, and the molded middle opening 36 of the housing with the comb 38 attached. This view represents the space that the accessories will has to reside within the accessories receptacle or housing unit. This bottom opening 40 will be used for concealing the accessories tube receptacle 42 which has a generally cylindrical outer configuration.

FIG. 8 illustrates perspective view an embodiment similar to FIG. 6. FIG. 8 is displaying the accessories tube receptacle 42 and the bottom opening of housing unit 40. The accessories tube receptacle 42 placed into the bottom opening 40 within the receptacle or housing unit 20 of the Combo Hair and Fur Grooming Kit with Accessories Compartment 22. This illustrates also again, shows the top opening of the housing unit 32 and the threads on the housing unit 34.

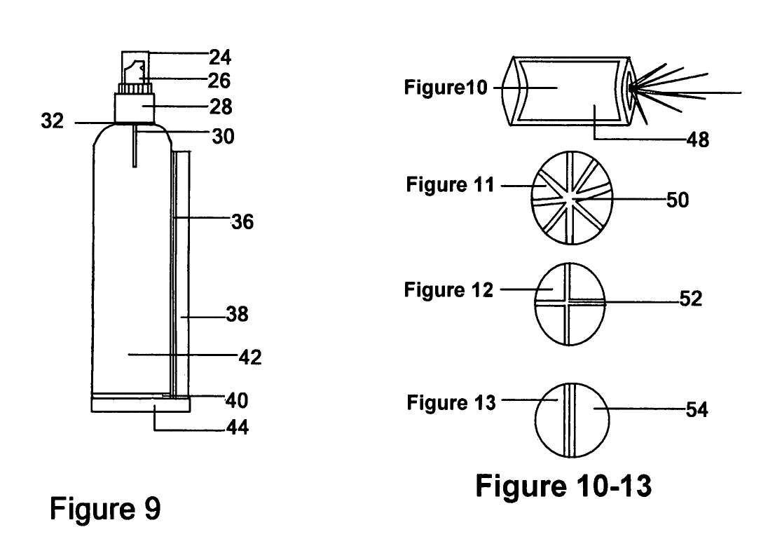

FIG. 9 illustrates a perspective of a Combo Hair or Fur Grooming Kit with an Accessories Compartment 22. This view gives a complete picture of the invention 20, starting with the cap of spray bottle 24, nozzle of spray bottle 26, neck of spray bottle 28, stem of spray bottle 30, top opening of housing unit 32, middle opening of housing unit 36, comb or brush 38, bottom opening of housing unit 40, accessories tube receptacle 42, and the end closure for the bottom opening 44. These spray bottles can range in sizes, shapes or colors and be manufactured of any material known to one skilled in the art of spray bottle manufacturing.

FIG. 10-14 illustrates a perspective assortment of end caps that can be attached to the Combo Hair or Fur Grooming Kit with an Accessories Compartment 22. These different ends 48, 50, 52 and 54 can be attached to the housing unit bottom opening of the housing unit for different type of closure or to use Accessories Compartment in a different way.

The embodiments of the invention in which an exclusive privilege or property is claimed are defined as below:

1. A portable one piece “Combo Hair or Fur Grooming Kit with an Accessories Compartment comprising of: a) a housing unit having a top portion receptacle, a middle portion receptacle and a bottom receptacle connected to said housing and said housing containing; b) a integral spray bottle inserted in the top portion of said housing; c) a integral handgrip or base connected to a comb/brush or a base combination of base and comb/brush inserted in the middle portion of said housing; d) a integral accessories tube receptacle integral inserted in the bottom portion of said housing; or e) if conceivable during manufacturing of said housing, a one piece integral tool for the grooming of humans or animals and storage for accessories into said bottom portion of said housing; f) said housing made of lightweight fabric or plastic allowing cooperative means of moveability and portability; g) of a size and shape that fits a human hand and for easy usage.

2. A Combo Hair or Fur Grooming Kit with an Accessories Compartment as recited in claim 1 wherein: said housing contains a top portion receptacle and a middle portion receptacle; said top and middle portion receptacles are made of plastic or any other shapeable material hard enough to stand alone; said top and middle portion receptacles are sealed at the perimeters to form one receptacle or housing unit; three openings will be constructed during this sealing of said top and middle portion receptacle. The top opening will be for the insertion of the spray bottle, The middle opening will be for the insertion of the base of comb or brush, and the bottom opening will be for the insertion of the accessories tube receptacle compartment that will hold such item needed to groom the hair of humans or pets.

3. A Combo Hair or Fur Grooming Kit with an Accessories Compartment as recited in claim 2 wherein: said housing can be in many shapes, colors and sizes; said top portion receptacle is to contain spray bottle and all its parts; said middle portion receptacle will contain a handgrip which will be connected to the comb or brush; said accessories tube receptacle will be inserted at the bottom of the receptacle within the interior of said housing

4. A Combo Hair or Fur Grooming Kit with an Accessories Compartment as recited in claim 3 wherein: said housing can range in various sizes; said housing should not be of a size that would be uncomfortable in a humans hand for usage on a human or pet; said housing can be in various colors, but not limited to black, white, gray, etc, and in various materials, not limited to plastic.

5. A Combo Hair or Fur Grooming Kit with an Accessories Compartment as recited in claim 1 wherein: said housing unit is made as a one piece unit with three constructed openings; a top opening for the spray bottle nozzle, tube and the cap; The top opening of said housing unit is for the connection of the spray bottle nozzle and cap, this part of said housing unit will hold liquids in the range from 1 to 8 ounces. The pump nozzle, tube, and cap will be made of plastic; The neck (top opening of the one piece said housing unit) will be made of plastic or a light weight metal; the threads on the top opening of the said unit and will be manufactured as part of the one piece housing unit; said spray nozzle and cap will then be secured into said top opening of said receptacle; said top opening will have a pump nozzle, tube, and a cap, this will then be threaded onto the top opening of said unit and become part of the spray bottle base of said housing unit.

6. A Combo Hair or Fur Grooming Kit with an Accessories Compartment as recited in claim 5 wherein: said spray bottle cap can be opened to expose said pump nozzle which will apply the liquid inside the spray bottle to the hair or fur of a human or pet; said spray cap will then be closed cover the pump nozzle of said spray bottle; said closure will ensure that liquid does not leak out of said top opening of said housing unit.

7. A Combo Hair or Fur Grooming Kit with an Accessories Compartment kit as recited in claim 1 wherein: said housing made with three constructed openings; a middle opening acting as a base for the insertion of a comb or brush; said base can range is various widths, thickness and lengths; said base will be manufactured as part of the main said housing unit; said housing unit can be made out of plastic, rubber, styrofoam, metal or anything suitable for this design; said comb and brushes will have an elongated dimension and a relatively narrow transverse dimension comb or brush blade which attaches to said housing unit as a base.

8. A Combo Hair or Fur Grooming Kit with an Accessories Compartment as recited in claim 7 wherein: said comb or brush can range in length and depth; said comb or brush should be no longer than said middle opening of said housing unit; said comb or brush can be made of any material know to one skilled in the art of manufacturing combs or brushes; when said comb or brush is inserted into middle opening of said receptacle in said housing unit; said comb or brush are then secured into said receptacle by bringing the two sides of receptacle together at said middle opening; said two sides are attached with glue or stitching to form the base or handgrip of said housing; said comb or brush should be attached in a manner that the operator will be able to drag said comb or brush along the hair of any human or the head and body of any pet to style human hair or pet fur in a easy manner.

9. A Combo Hair or Fur Grooming Kit with an Accessories Compartment as recited in claim 1 wherein: said housing unit is made up of three constructed openings; a bottom opening at the end of said housing unit is for the insertion of the accessories tube receptacle into the said housing; said accessories tube receptacle will be made of plastic, PVC, metal or paper; said accessories tube receptacle and will be manufactured as part of the one piece housing unit; a cap or closure of some type will be connected to the bottom opening to ensure the closure of said bottom opening at the end of said housing unit; this bottom opening of said housing unit will hold accessories for styling human hair or pet fur from falling out of accessories tube receptacle of said housing unit.

10. A Combo Hair and Fur Grooming Kit with an Accessories Compartment as recited in claim 1 wherein: said housing unit is equipped with a detachable closure at the bottom of the accessories tube receptacle of said housing unit. This closure could be removed and replaced with a towel to dry off human hair or animal fur and stored in said accessories tube receptacle of said housing unit.

11. A Combo Hair and Fur Grooming Kit with an Accessories Compartment as recited in claim 8 wherein: If conceivable during manufacturing of this said housing unit, a one piece integral styling tool with a comb or brush built into the middle opening without the need to connect the comb or brush to the middle receptacle of said housing unit; said comb or brush will be manufactured as part of the one piece housing unit.

12. A Combo Hair and Fur Grooming Kit with an Accessories Compartment as recited in claim 9 wherein: If conceivable during manufacturing of this said housing unit, a one piece integral styling tool with a built in closures into the bottom opening without the need to connect the closure to the bottom receptacle of said housing unit; said closure will be manufactured as part of the one piece housing unit.

13. A Combo Hair and Fur Grooming Kit with an Accessories Compartment as recited in claim 1 wherein: said housing unit will be made of any lightweight plastic allowing for recycling of the product by allowing the top opening of the housing unit to be refilled with whatever styling product or water over and over again; said housing must allow for easy move ability of said housing unit; said housing unit will be a easy operational styling unit with everything one would need to groom human hair or pet fur.

14. A Combo Hair and Fur Grooming Kit with an Accessories Compartment as recited in claim 13 wherein: said housing is of a size and shape that it conveniently sits on any counter top, fits in a handbag, shoulder bag, in a car, boat or RV; said receptacle is within reach for ready access in the event of sudden extreme hair or fur grooming conditions which would require emergency measures without the operator leaving there current situation or placement.

15. Other objects and advantages of the present invention will become apparent from a careful reading of the detailed description provided herein, with appropriate reference to the accompanying drawings.
